(19) United States
(12) Patent Application Publication
(10) Pub. No.: US 2025/0102108 A1
(43) Pub. Date: Mar. 27, 2025

(54) SELF-SEALING MOUNTING BRACKET

(71) Applicant: Paul Budge, St. George, UT (US)

(72) Inventor: Paul Budge, St. George, UT (US)

(21) Appl. No.: 18/900,533

(22) Filed: Sep. 27, 2024

Related U.S. Application Data
(60) Provisional application No. 63/585,854, filed on Sep. 27, 2023.

(51) Int. Cl. F16M 13/02

(52) U.S. Cl. CPC F16M 13/02

(57) ABSTRACT

A bracket includes a first member and a second member extending away from the first member in a first direction. The bracket includes a sealant disposed on a surface of the first member. The surface faces a second direction substantially opposite to the first direction. The bracket includes at least one port extending through a thickness of the first member and configured to receive a fastener to secure the bracket to a mounting surface.

### CROSS-REFERENCE TO RELATED APPLICATION

This application claims the benefit of U.S. Provisional Patent Application No. 65/585,854, filed Sep. 27, 2023, which is incorporated herein by reference.

### FIELD

This disclosure relates generally to mounting brackets and more particularly to self-sealing mounting brackets.

### BACKGROUND

Mounting brackets are devices used to secure objects to a surface. They are commonly found in construction, manufacturing, and transportation industries. Mounting brackets can be made from various materials, such as metal, plastic, or wood, depending on the specific requirements of the application. Mounting brackets can be used to secure a variety of objects, including equipment, fixtures, and signage.

### SUMMARY

The subject matter of the present application has been developed in response to the present state of the art, and in particular, in response to the shortcomings of mounting brackets, that have not yet been fully solved by currently available techniques. Accordingly, the subject matter of the present application has been developed to provide a self-sealing mounting bracket and corresponding system that overcome at least some of the above-discussed shortcomings of prior art techniques.

The following is a non-exhaustive list of examples, which may or may not be claimed, of the subject matter, disclosed herein.

The following portion of this paragraph delineates example 1 of the subject matter, disclosed herein. According to example 1, a bracket includes a first member and a second member extending away from the first member in a first direction. The bracket includes a sealant disposed on a surface of the first member. The surface faces a second direction substantially opposite to the first direction. The bracket includes at least one port extending through a thickness of the first member and configured to receive a fastener to secure the bracket to a mounting surface.

The following portion of this paragraph delineates example 2 of the subject matter, disclosed herein. According to example 2, which encompasses example 1, above, the bracket includes at least one inspection port extending through the thickness of the first member. The sealant is visible through the at least one inspection port, accessible through the at least one inspection port, and/or a combination thereof.

The following portion of this paragraph delineates example 3 of the subject matter, disclosed herein. According to example 3, which encompasses example 1 or 2, above, the sealant is configured to flow into the inspection port in response to force being applied to the first member in the second direction.

The following portion of this paragraph delineates example 4 of the subject matter, disclosed herein. According to example 4, which encompasses any one of examples 1-3, above, the system includes at least one plug configured to be removably received by the at least one inspection port.

The following portion of this paragraph delineates example 5 of the subject matter, disclosed herein. According to example 5, which encompasses any one of examples 1-4, above, the sealant is configured to flow in a third direction substantially perpendicular to the second direction in response to force being applied to the sealant in the second direction.

The following portion of this paragraph delineates example 6 of the subject matter, disclosed herein. According to example 6, which encompasses any one of examples 1-5, above, the sealant includes a material having a kinematic viscosity of not less than 100 and not greater than 50,000 centistokes (“cSt”).

The following portion of this paragraph delineates example 7 of the subject matter, disclosed herein. According to example 7, which encompasses any one of examples 1-6, above, the sealant is attached to the surface of the first member.

The following portion of this paragraph delineates example 8 of the subject matter, disclosed herein. According to example 8, which encompasses any one of examples 1-7, above, the bracket includes a protective film. The sealant contacts the surface of the first member at a first sealant surface of the sealant, and the removable protective film is removably disposed over a second sealant surface of the sealant opposite to the first sealant surface.

The following portion of this paragraph delineates example 9 of the subject matter, disclosed herein. According to example 9, which encompasses any one of examples 1-8, above, the bracket includes a third member coupled to a surface of the second member. The first member extends away from the second member in a third direction and the surface faces a fourth direction opposite to the third direction.

The following portion of this paragraph delineates example 10 of the subject matter, disclosed herein. According to example 10, which encompasses any one of examples 1-9, above, the third member further includes a bracket attachment surface and a curved surface opposite the bracket attachment surface.

The following portion of this paragraph delineates example 11 of the subject matter, disclosed herein. According to example 11, which encompasses any one of examples 1-10, above, at least a portion of the bracket attachment surface of the third member is attached to the surface of the second member and a concave side of the curved surface faces the fourth direction.

The following portion of this paragraph delineates example 12 of the subject matter, disclosed herein. According to example 12, which encompasses any one of examples 1-11, above, the sealant includes at least one of: an acrylic material, a silicone material, a polymeric material, a latex material, a rubber material, an oil, and/or any combination thereof.

The following portion of this paragraph delineates example 13 of the subject matter, disclosed herein. According to example 13, which encompasses any one of examples 1-12, above, the sealant includes a material selected to harden in response to contact with air.

The following portion of this paragraph delineates example 14 of the subject matter, disclosed herein. According to example 14, which encompasses any one of examples 1-13, above, the sealant is configured to flow through the thickness of the first member via the at least one port, an additional port in the first member, or a combination thereof.

The following portion of this paragraph delineates example 15 of the subject matter, disclosed herein. According to example 15, which encompasses any one of examples 1-14, above, the sealant is configured to harden in response to contact with air after flowing through the thickness of the first member.

The following portion of this paragraph delineates example 16 of the subject matter, disclosed herein. According to example 16, a system includes a fastener and a bracket. A bracket includes a first member and a second member extending away from the first member in a first direction. The bracket includes a sealant disposed on a surface of the first member. The surface faces a second direction substantially opposite to the first direction. The bracket includes at least one port extending through a thickness of the first member and configured to receive the fastener to secure the bracket to a mounting surface.

The following portion of this paragraph delineates example 17 of the subject matter, disclosed herein. According to example 17, which encompasses example 16, above, at least one port is configured to receive the fastener to secure the bracket to the mounting surface such that the sealant is interposed between the first member and the mounting surface when the bracket is secured to the mounting surface.

The following portion of this paragraph delineates example 18 of the subject matter, disclosed herein. According to example 18, which encompasses any one of examples 16-17, above, the sealant is configured to form a seal between the mounting surface and the first member when the bracket is secured to the mounting surface.

The following portion of this paragraph delineates example 19 of the subject matter, disclosed herein. According to example 19, which encompasses any one of examples 16-18, above, the sealant is configured to flow into the port and fill an interstitial space between the fastener and the port when the fastener secures the bracket to the mounting surface.

The following portion of this paragraph delineates example 20 of the subject matter, disclosed herein. According to example 20, a bracket includes a first member and a second member extending away from the first member in a first direction. The bracket includes a sealant disposed on a surface of the first member, the surface facing a second direction substantially opposite to the first direction. The bracket includes a first port extending through a thickness of the first member and configured to receive a fastener to secure the bracket to a mounting surface. The bracket includes a second port extending through the thickness of the first member. The sealant is visible through the second port and configured to flow into the second port and through the thickness of the first member in response to force being applied to the first member in the second direction

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A, illustrates a top perspective view of a self-sealing mounting bracket in accordance with one or more examples of the present disclosure;

FIG. 1B illustrates a side view of a self-sealing mounting bracket, according to one or more examples of the present disclosure;

FIG. 1C illustrates a bottom perspective view of a self-sealing mounting bracket, according to one or more examples of the present disclosure;

FIG. 2A illustrates a cross-section of a system, according to one or more examples of the present disclosure;

FIG. 2B illustrates a cross-section of a system with a fastener securing a self-sealing mounting bracket to a mounting surface, according to one or more examples of the present disclosure; and

FIG. 3 illustrates a top perspective view of a system having a bracket, a protective film, and a protective plug, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

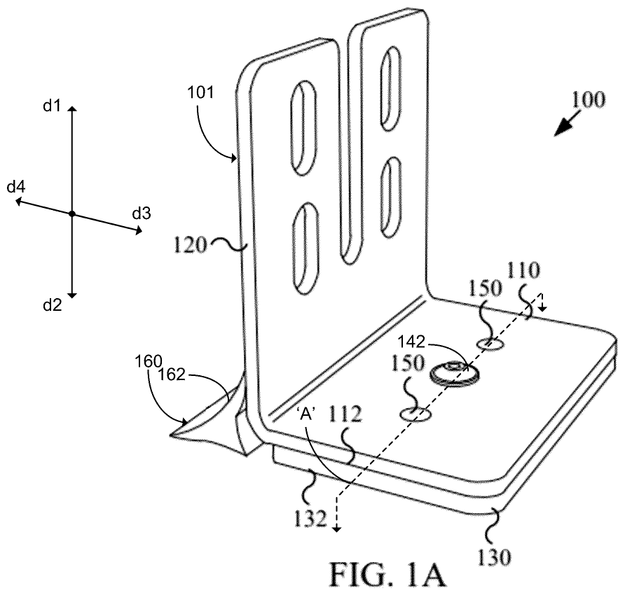

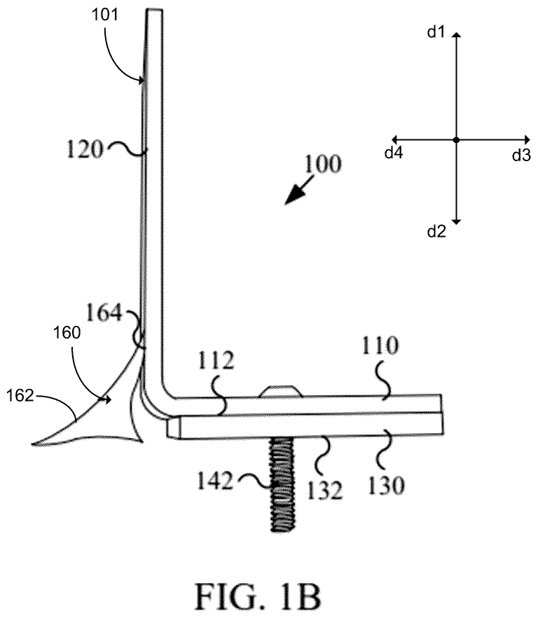

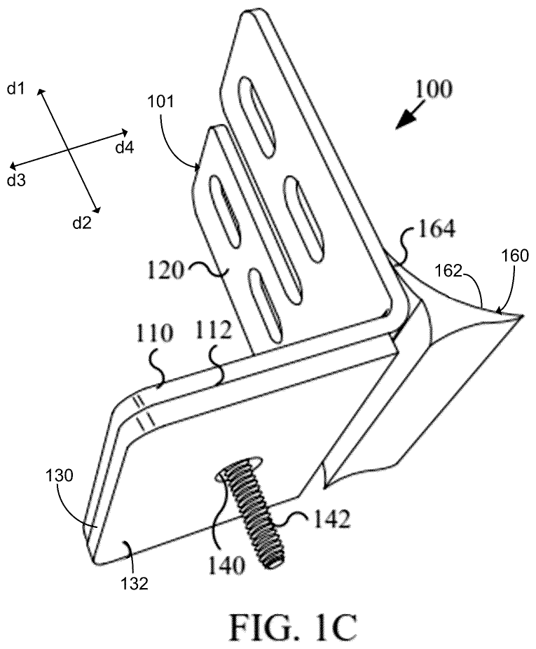

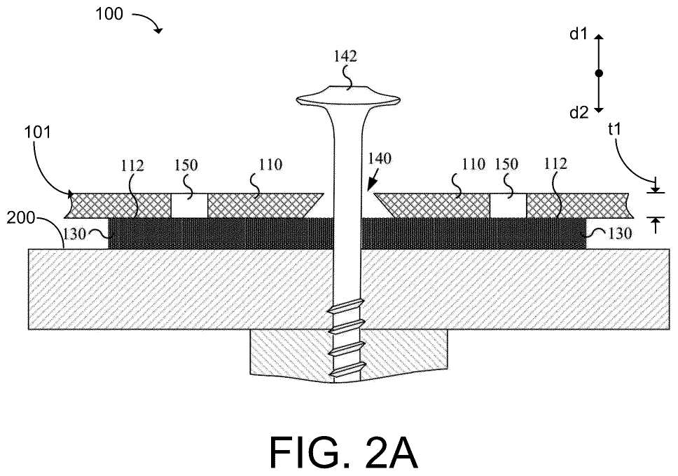

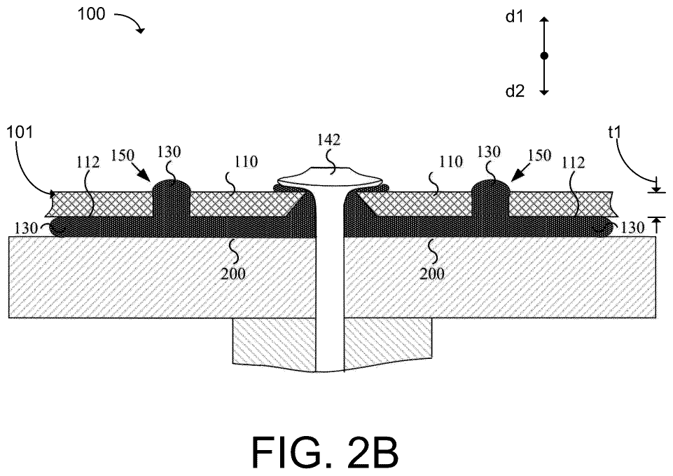

Referring to FIGS. 1A-2B, a system 100 includes a bracket 101 and a fastener 142. In some examples, the bracket 101 includes a first member 110, a second member 120 and a sealant 130 disposed on a surface 112 of the first member of the bracket 101. In some examples, the second member 120 extends away from the first member 110 in a first direction d1.

In some examples, the first member 110 is perpendicular to the second member 120 as shown in FIGS. 1A-1C. In other examples, the first member 110 is at an angle approximately 45-degrees relative to the second member 120. The first member 110 may be at any angle relative to the second member 120. In some examples, the first and second members 110, 120 are co-formed as one singular bracket 101. In alternate examples, the first member 110 is coupled to the second member 120 to form a singular bracket 101. In some examples, the first member 110 is welded, molded, and/or fastened to the second member 120. In some examples, the second member 120 is attached to the first member 110 at a surface of the first member 110 that is opposite to the surface 112 on which the sealant 130 is disposed. In some examples, the bracket 101 includes an additional member substantially parallel to the first member 110 such that the additional member and the first member 110 sandwich the sealant 130, and the first member 110 moves toward the additional member in response to force being applied in the second direction d2.

In some examples, the sealant 130 is disposed on a surface 112 of the first member 110. In some examples, the surface 112 is a bottom surface of the bracket 101. In some examples, the surface 112 is a surface facing away from the second member 120. In some examples, the surface 112 faces a second direction d2 that is substantially opposite to the first direction d1.

As used herein, the term “sealant” refers to any material used to form a seal between the mounting surface 200 and the bracket 101. In some examples, the seal is a waterproof seal. In some examples, the sealant 130 includes a viscous material. In some examples, the viscous material includes: latex, epoxy, resin, mastic, silicone, an acrylic material, caulk, oil, pigment, putty, butyl, rubber, and/or any combination thereof. In some examples, the material includes a pre-cured rubber mastic material or other materials with self-mending capabilities. In other examples, the sealant 130 material is a partially cured soft rubber or silicone-based material which maintains some viscous properties when acted upon by an outside force. In some examples, the sealant 130 is of sufficient strength to maintain its shape unless acted upon by an outside force. In some examples, the sealant 130 is temporarily a viscous material until the sealant 130 has properly cured. In some examples, the sealant 130 is a sticky, yet flexible material. In some examples, the sealant 130 is selected to cure and/or harden in response to contact with air.

Referring to FIGS. 2A-2B, in some examples, the sealant 130 is disposed on the surface 112 of the first member 110. Referring to FIG. 1A, before the bracket 101 is fastened to a mounting surface 200, the sealant 130 is disposed on the surface 112 of the first member 110 and takes a first shape. Referring to FIG. 1B, as the bracket 101 is fastened to the mounting surface 200, pressure is applied to the sealant 130, causing a change in the shape and/or dimensions of the sealant 130. In some examples, the threshold pressure is between 30 N and 200 N. In some examples, the sealant 130 expands along the surface 112 and/or along the mounting surface 200. In some examples, the sealant 130 flows into and/or around one or more deformities in the mounting surface 200, such as rivets, ridges, holes, gaps, and/or any combination thereof. In some examples, the sealant 130 forms a suction tight waterproof seal between the bracket 100 and the mounting surface 200. In some examples, the sealant 130 is selected to flow into openings (e.g., port 150) of the first member 110 in response to the added pressure.

In some examples, the self-sealing bracket 101 also includes at least one securement port 140 that enables securing the bracket 101 to an exterior mounting surface 200 with a fastener 142. In some examples, the securement port 140 extends through a thickness t1 of the first member 110. In some examples, the securement port 140 is substantially aligned with an opening in the sealant 130. Although not shown in the Figures, in some examples, the securement port 140 includes one or more features configured to mate with a fastener 142, such as a threaded portion configured to mate with a threaded portion of the fastener 142. In some examples, the securement port 140 has a minimum width greater than a minimum width of the fastener 142.

In some examples, the sealant 130 will flow to other portions of the bracket 101 in response to pressure from the tightened fastener 142 through the securement port 140. In some examples, as the pressure is applied to the sealant 130 by fastening the bracket 101 to the mounting surface 200, the sealant 130 forms a seal between the first member 110 and the mounting surface 200. In some examples, as the fastener 142 is tightened, the sealant 130 molds or conform to the mounting surface 200. In some examples, the sealant 130 forms a seal between the fastener 142 and the walls of the securement port 140 by filling an interstitial space between the fastener 142 and the walls of the securement port 140. In some examples, the sealant 130 is interposed between the first member 110 and the mounting surface 200 when the bracket 101 is mounted to the mounting surface 200. In some examples, the sealant 130 will cure around the fastener 142 and the walls of the securement port 140 such that a seal is maintained if the fastener 142 is removed, lost, or compromised.

Referring to FIGS. 2A-2B, the mounting surface 200 includes a surface of any object or feature to which the bracket 101 is fastened. The mounting surface 200 includes, in some examples, dirt, roofing, asphalt, shingles, tiles, brick, stone, glass, clay, slate, concrete, rubber, wood, stucco, and metal, and/or any combination thereof. In some examples, the mounting surface 200 includes an opening or other feature configured to receive and/or mate with the fastener 142. In some examples, the fastener 142 is configured to create an opening in the mounting surface 200. For example, the fastener 142 includes a screw that is driven into the mounting surface 200 by turning the screw.

In some examples, the bracket 101 includes at least one inspection port 150 that enables inspection of the sealant 130. In some examples, the inspection port 150 enables inspection of the flow of the sealant 130. For example, a user can look through the inspection port 150 to visually confirm that the sealant 130 has flowed along the surface 112 of the bracket 101 in response to added pressure from securing the bracket 101 to the mounting surface 200. In some examples, the inspection port 150 enables non-visual inspection of the sealant 130. For example, the inspection port 150 enables a probe, thermometer, or other measurement device to access the sealant 130 via the inspection port 150. In some examples, the inspection port 150 is separate from the securement port 140. In some examples, the bracket 101 includes a plurality of inspection ports 150 spaced equidistant from each other. In some examples, the bracket 101 includes two inspection ports 150 positioned laterally apart with respect to the securement port 140. In some examples, the securement port 140 is substantially centered with respect to the two inspection ports 150. In some examples, the inspection ports 150 have a width that is less than a width of the securement port 140. In some examples, a distance between the securement port 140 and the inspection port 150 is not less than one eighth of a length of the first member 110.

In one example, the at least one inspection port is an opening extending through the thickness t1 of the first member 110. In some examples, the pre-cured sealant 130 flows up and through the thickness of the at least one inspection port 150. In some examples, the sealant 130 flows through the at least one inspection port 150 and encase the fastener 142 but the sealant 130 does not extend past the exterior edges of the first member 110. In another example, the inspection port 150 includes a transparent window which allows a user to see the sealant 130 through the inspection port 150. In some examples, a user can confirm that the bracket 101 is properly mounted and secured when a viscous sealant 130 has filled the inspection port 150 and/or is visible through the inspection port 150. In some examples, the system 100 includes a plunger system within the inspection port 150. The plunger system includes a plunger that starts in a compressed position and rises as the sealant 130 fills the inspection port 150 (e.g., as the sealant 130 flows in response to pressure from the fastening, as shown in FIG. 2B). In such examples, an extended plunger signifies that the sealant 130 has filled the inspection port 150.

In some examples, as shown by FIGS. 1A-1C, the self-sealing bracket 101 includes a precipitation deflection member 160 disposed on a backside of the second member 120 of the bracket 101. In one example, the depicted precipitation deflection member 160 included a curved deflection surface 162 and a bracket attachment surface 164. Referring to FIGS. 1A-1C, at least a portion of the bracket attachment surface 164 of the precipitation deflection member 160 is bonded to the backside of the second member 120 of the bracket. In other examples, the precipitation deflection member 160 is co-formed with the first and second members 110, 120 of the bracket 101, such that the first member 110, second member 120, and precipitation deflection member 160 form a uniform construction. In another example, the precipitation deflection member 160 is bonded to the bracket 101 by welding or other manufacturing means. In some examples, the precipitation deflection member 160 helps to reduce the amount of precipitation introduced to the sealant 130. In some examples, the curved surface 162 of the deflective member 160 includes a concave side that faces a fourth direction d4 opposite to a third direction d3 in which the first member 110 extends.

FIGS. 2A and 2B illustrate a cross-sectional side view of the system 100, which includes a bracket 101 mounted on a mounting surface 200 in accordance with at least one example disclosed herein. FIGS. 2A and 2B are cross-sections along the virtual plane ‘A’ shown in FIG. 1A. Fastening the self-sealing bracket 101 to the mounting surface 200 causes the sealant 130 to flow laterally along the mounting surface 200 and the bottom surface 112 of the first member 110. In some examples, the sealant 130 flows vertically through an inspection port 150 and/or the securement port 140 and thereby seal around the fastener 142. In some examples, the viscosity of the sealant 130 is selected to enable the sealant 130 to flow at a minimum acceptable mounting pressure for the self-sealing bracket 101. In some examples, the viscosity of the sealant 130 enables the viscous sealant 130 to conform to variations and imperfections in the mounting surface 200 as well as variations in the position and orientation of the fastener(s) 142 and thereby improve the sealing properties of the self-sealing bracket 101.

In some examples, the sealant 130 includes a viscous fluid. In some examples, the sealant 130 has a kinematic viscosity of not less than 0.65 and not greater than 2,500,000 centistokes (“cSt”). In some examples, the sealant 130 has a kinematic viscosity of not less than 100 and not greater than 50,000 cSt. In some examples, the sealant 130 has a kinematic viscosity of not less than 100 and not greater than 10,000 cSt. In some examples, the sealant 130 has a kinematic viscosity of not less than 50,000 cSt and not greater than 2,500,000 cSt. In some examples, the sealant 130 has a viscosity of not less than 4 and not greater than 45 cSt. In some examples, the sealant 130 has a viscosity of not less than 40 and not greater than 65 cSt. In some examples, the sealant 130 includes a hardening and/or drying agent.

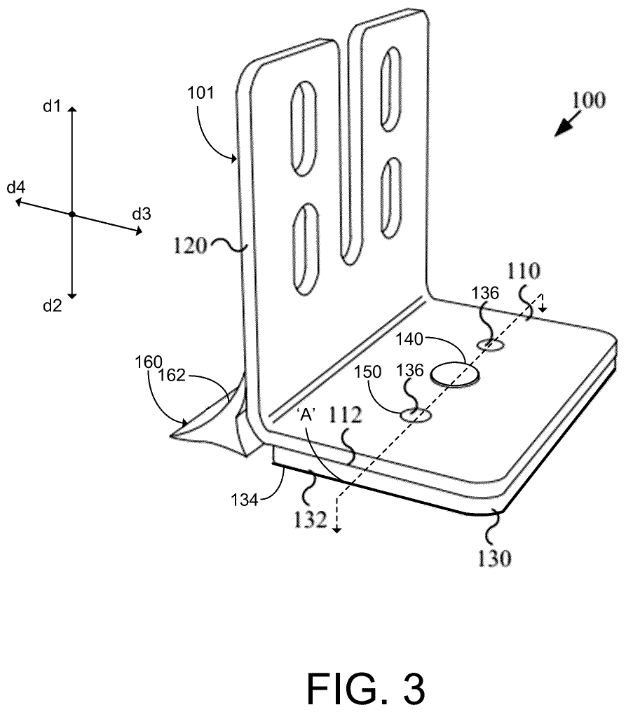

Referring to FIG. 3, in some examples, the system 100 includes a protective film 134 disposed over an exposed surface 132 of the sealant 130. In some examples, the disposed surface 132 is a surface opposite to the first member 110 and is exposed when the bracket 101 is not mounted to a mounting surface 200. In some examples, the protective film 134 helps to protect the sealant 130 from dirt and debris prior to mounting. In some examples, the protective film 134 is removable. In some examples, the sealant 130 is a non-hardening material.

In some examples, the system 100 includes one or more protective plugs 136. In some examples, the protective plugs 136 are disposed within the securement port 140 and/or the inspection port 150. In some examples, the protective plugs 136 help to protect the viscous sealant 130 from dirt, debris and, in some examples, hardening. In some examples, the protective plugs 136 are removable previous to mounting of the bracket 101 to the mounting surface 200.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein, a plurality of particular features does not necessarily mean every particular feature of an entire set or class of the particular features.

The term “about” or “substantially” or “approximately” in some examples, is defined to mean within +/−5% of a given value, however in additional examples any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate examples or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate examples or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, as used herein, securing one element to another element can include direct securing and indirect securing. Additionally, as used herein, “adjacent” does not necessarily denote contact. For example, one element can be adjacent to another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The examples described are to be considered in all respects only as illustrative and not restrictive. All changes which come within the meaning and range of equivalency of the claims are to be embraced within their scope.

What is claimed is:

1. A bracket comprising:
a first member;
a second member extending away from the first member in a first direction;
a sealant disposed on a surface of the first member, the surface facing a second direction substantially opposite to the first direction; and
at least one port extending through a thickness of the first member and configured to receive a fastener to secure the bracket to a mounting surface.

2. The bracket of claim 1, further comprising at least one inspection port extending through the thickness of the first member, wherein the sealant is visible through the at least one inspection port.

3. The bracket of claim 2, wherein the sealant is configured to flow into the inspection port in response to force being applied to the first member in the second direction.

4. The bracket of claim 2, further comprising at least one plug configured to be removably received by the at least one inspection port.

5. The bracket of claim 1, wherein the sealant is configured to flow in a third direction substantially perpendicular to the second direction in response to force being applied to the sealant in the second direction.

6. The bracket of claim 1, wherein the sealant comprises a material having a kinematic viscosity of not less than 100 and not greater than 50,000 centistokes (“cSt”).

7. The bracket of claim 1, wherein the sealant is attached to the surface of the first member.

8. The bracket of claim 1, further comprising a protective film, wherein the sealant contacts the surface of the first member at a first sealant surface of the sealant, and the protective film is removably disposed over a second sealant surface of the sealant opposite to the first sealant surface.

9. The bracket of claim 1, further comprising a third member coupled to a surface of the second member, wherein the first member extends away from the second member in a third direction and the surface faces a fourth direction opposite to the third direction.

10. The bracket of claim 9, wherein the third member further comprises a bracket attachment surface and a curved surface opposite the bracket attachment surface.

11. The bracket of claim 10, wherein at least a portion of the bracket attachment surface of the third member is attached to the surface of the second member and a concave side of the curved surface faces the fourth direction.

12. The bracket of claim 1, wherein the sealant comprises at least one of: an acrylic material, a silicone material, a polymeric material, a latex material, a rubber material, an oil, and/or any combination thereof.

13. The bracket of claim 1, wherein the sealant comprises a material selected to harden in response to contact with air.

14. The bracket of claim 1, wherein the sealant is configured to flow through the thickness of the first member via the at least one port, an additional port in the first member, or a combination thereof.

15. The bracket of claim 14, wherein the sealant is configured to harden in response to contact with air after flowing through the thickness of the first member.

16. A system, comprising:
a fastener; and
a bracket, comprising:
a first member;
a second member extending away from the first member in a first direction;
a sealant disposed on a surface of the first member, the surface facing a second direction substantially opposite to the first direction; and
at least one port extending through a thickness of the first member and configured to receive the fastener to secure the bracket to a mounting surface.

17. The system of claim 16, wherein the at least one port is configured to receive the fastener to secure the bracket to the mounting surface such that the sealant is interposed between the first member and the mounting surface when the bracket is secured to the mounting surface.

18. The system of claim 17, wherein the sealant is configured to form a seal between the mounting surface and the first member when the bracket is secured to the mounting surface.

19. The system of claim 16, wherein the sealant is configured to flow into the port and fill an interstitial space between the fastener and the port when the fastener secures the bracket to the mounting surface.

20. A bracket, comprising:
a first member;
a second member extending away from the first member in a first direction;
a sealant disposed on a surface of the first member, the surface facing a second direction substantially opposite to the first direction;
a first port extending through a thickness of the first member and configured to receive a fastener to secure the bracket to a mounting surface;
a second port extending through the thickness of the first member, wherein the sealant is visible through the second port and configured to flow into the second port and through the thickness of the first member in response to force being applied to the first member in the second direction.
